(19) United States
(12) Patent Application Publication
(10) Pub. No.: US 2019/0107017 A1
(43) Pub. Date: Apr. 11, 2019

(54) DEVICE FOR DEPOSITING OIL DROPLETS AND/OR OIL MIST

(71) Applicant: REINZ-DICHTUNGS-GMBH, NEU-ULM (DE)

(72) Inventors: SEBASTIAN BRINKER, NEU-ULM (DE); CHRISTOPH ERDMANN, ULM (DE); YAGIZ YAMAN, ULM (DE); PHILIPP ZEDELMAIR, ULM (DE); FRANCESCO ZITAROSA, ILLERTISSEN (DE)

(21) Appl. No.: 16/091,554

(22) PCT Filed: Apr. 6, 2017
(86) PCT No.: PCT/EP2017/058215

§ 371 Date: Oct. 5, 2018

(30) Foreign Application Priority Data
Apr. 6, 2016 (DE) 20 2016 101 814.5

(51) Int. Cl. F01M 13/04; F16K 15/16

(52) U.S. Cl. CPC F01M 13/04; F16K 15/16

(57) ABSTRACT

A device for separating oil droplets and/or oil mist from blow-by gases of an internal combustion engine having a valve for controlling the gas flow through the oil separator is disclosed. The valve has at least one valve body with at least one gas through-opening and also a valve seal for closing this at least one gas through-opening.

The present invention relates to a device for separating oil droplets and/or oil mist from blow-by gases of an internal combustion engine having a valve for controlling the gas flow through the oil separator. The valve has at least one valve body with at least one gas through-opening and also a valve seal for closing this at least one gas through-opening.

Nowadays, numerous oil separator geometries are configured adaptively so that an acceptable oil separation is possible over large ranges of different volume flows of blow-by gas to be cleaned. Some of these oil separator geometries use moveable spring steel segments which are connected subsequently to the oil separator geometries and can close these. The spring steel segments, when pre-set pressure differences are exceeded, open further oil separators so that a number of oil separation elements adapted to the volume flow are available for the oil separation. Oil separation is consequently possible in an effective manner over a wide range of possible volume flows so that the oil separation is improved in total. In order to open the spring steel segments, energy is however required which is then no longer available for the oil separation. Therefore the efficiency of the oil separator for each individual operating point, i.e. for each different volume flow, is reduced.

Starting from this state of the art, it is therefore the object of the present invention to make available a device for separating oil droplets and/or oil mist from blow-by gases of an internal combustion engine, in which the oil separation efficiency is improved in the case of many pressure differences and in the case of many different, in particular small, volume flows of the blow-by gas, and which is producible easily, quickly, economically and scalably.

This object is achieved by a device according to claim 1. Advantageous developments of the present invention are given in the dependent claims.

The device according to the invention for separating oil droplets and/or oil mist from blow-by gases of an internal combustion engine has a valve for controlling the gas flow from a pressure side to a suction side of the oil separator. This valve has a valve body with at least one gas through-opening, which is closable, by means of a valve seal, from the pressure side to the suction side of the valve. This valve seal is disposed on the suction side relative to the at least one gas through-opening for suction-side closure of this at least one gas through-opening and has at least one spring element with which the at least one gas through-opening can be closed. Each of the spring elements can be in particular a spring tongue. According to the invention, it is now provided that this spring element, on that surface which is orientated towards the gas through-opening, is coated with an elastic material. The coating is thereby effected at least in that region which is adjacent at least to one of the gas through-openings. In other words, the spring element is coated such that, upon closure of the gas through-opening by the spring element, the elastic material comes to lie on the circumferential edge of the gas through-opening and acts jointly in the sealing of the gas through-opening.

As a result of this coating, according to the invention, of the valve seal or of the spring element, excellent sealing is effected, on the one hand, upon closure of the valve. On the other hand, it has been shown that, even in the opened state, the separation behaviour of the oil separator is improved by the coating. In particular, the efficiency of the oil separation is improved. As a result of the elasticity of the coating, no complete recoil of oil droplets impinging on the surface of the spring element is effected but rather at least partial deceleration of the flow of oil particles. This effects an improvement in the oil separation. In particular in the case of small volume flows, the coating leads to a greatly improved separation of oil mist and oil droplets from the blow-by gases flowing through the gas through-opening.

The valve or the valve body can thereby be designed such that a baseplate which includes the gas through-openings is provided. The baseplate consequently has a pressure side and a suction side, blow-by gases being able to flow through the gas through-openings from the pressure side to the suction side. Advantageously, the gas through-openings on the suction side are delimited in radial direction by walls which protrude in the direction of the suction side or in the direction of the spring element beyond the baseplate.

The efficiency of the separation of oil mist and/or oil droplets is improved more greatly by the wall of such a gas through-opening advantageously having a small wall thickness, in particular along the circumferential edge of the gas through-opening. Particularly advantageously, the wall, on its suction-side end, has a sharp edge with a small radius of curvature or a tapering region. Alternatively, it has a type of circumferential, protruding collar on the suction side.

Consequently, the region between the coating of the spring element and the suction-side end of the wall of the gas through-opening is configured in a particular manner. It has been shown that, as a result of the coating of the spring element in conjunction with the particular configuration of the suction-side end of the wall of the gas through-opening, the efficiency of the oil separation is increased further. The combination of the coating of the spring element and of the particular design of the suction-side end of the wall of the gas through-opening thereby leads to a disproportionate improvement in the separation efficiency.

In particular, the gas through-opening in the cover region of the wall which is directly adjacent to the spring element, i.e. on its suction-side end on which it comes in contact with the spring element upon closure of the valve, can have a particularly small wall thickness or have a particularly small radius of curvature or even taper at a particularly small angle.

Thus typically the walls of such gas through-openings in the state of the art have wall thicknesses of over 0.8 mm and, between adjacent through-openings, of over 1.2 mm. According to the invention, now at least on the last 0.1 mm length on the suction-side, there is provided a wall thickness of ≤0.5 mm, advantageously of ≤0.2 mm. In particular, on the last 0.5 mm length or more of the wall of the gas through-opening on the suction-side, there can be a wall thickness of ≤0.5 mm, advantageously of ≤0.2 mm.

For determining the radius of curvature of the suction-side sealing edge of the wall of the gas through-opening, for example the last 0.1 mm to 1 mm of the length can be considered. Average radii of curvature are then advantageously, according to the invention, ≤1.0 mm, preferably ≤0.5 mm, preferably ≤0.2 mm, preferably ≤0.1 mm.

If the suction-side circumferential edge of the wall of the through-opening is provided with an edge which tapers, then, for example for determining the angle, that angle of the edge can be considered which is produced between tangents to the outer and inner surfaces of the wall at a spacing between 0.3 mm and 0.6 mm from the free suction-side end of the wall. According to the invention, the angle determined for example in such a manner is advantageously ≤45°, advantageously ≤30°, particularly preferably ≤15°.

In a further advantageous configuration of the mentioned cover region, i.e. of the region provided on the suction-side end of the wall in which the wall comes in contact with the coating of the spring element, the ratio between the free cross-sectional area of the gas through-opening in this cover region or at the open end of the wall and of the contact surface between the wall and the elastic material, can be a ratio ≥5, preferably ≥10, particularly preferably ≥50. Alternatively or additionally, it is also possible to configure that surface of the elastic material which is surrounded by the mentioned contact surface such that it has a surface ratio with the contact surface itself which is ≥5, preferably ≥10, particularly preferably ≥50. As a result, the cover region or the contact surface relative to the enclosed area which is the cross-sectional area of the gas through-opening or the area enclosed by the contact surface, is very small. In all these embodiments of the cover region of the wall of the gas through-opening, very good efficiency of the oil separation is produced.

The particular configuration of the suction-side end of the wall of the at least one gas through-opening enables a small immersion of the suction-side end of the wall in the coating so that, on the one hand, a better seal of the suction-side end of the gas through-opening is provided and, on the other hand, also the oil separation is improved since, inter alia, a more precise opening and closing of the spring element results.

The coating of the spring element can advantageously consist of an elastomer, preferably one of the following materials, polyacrylate rubber (ACM), ethylene acrylate rubber (AEM), fluorosilicone rubber (FVMQ), fluorinated rubber (FKM), silicone rubber (VMQ), epichlorohydrin rubber (ECO), perfluorinated rubber (FFKM), nitrile-butadiene rubber (NBR), hydrated nitrile-butadiene rubber (HNBR), chloroprene rubber (CR), thermoplastic elastomers (TPE), and also blends and/or mixtures of these materials, or comprise these.

In particular the material does not comprise or is not a filter material which would allow passage of the blow-by gases through the material. Advantageously, the material of the coating of the spring element is or comprises a closed-pore material or has this at least in regions or in individual layers, in particular in or on an outer surface layer orientated away from the spring element. The coating can also consist only of a single layer with a possibly uniform closed-pore material.

The coating can, as indicated already, also be multilayer so that the above data apply with respect to the materials of the coating, at least for one of the coating layers, in particular for the outermost layer of the coating orientated towards the gas through-opening. For example, there can be applied directly on the surface of the spring element a very elastic, open-pore, foamed coating which is covered by a less elastic closed-pore coating. As a result, the elastic properties of the open-pore coating can be used without a risk of contamination of the coating occurring.

The coating advantageously has a thickness D with 0.2 mm≤D≤1.0 mm, preferably 0.3 mm≤D≤0.5 mm.

The spring element is thereby coated in particular at least in the region or the regions which is/are situated opposite the gas through-openings. It can be partially coated for this purpose, in particular in the cover region and in regions adjacent thereto. Advantageously, the spring element is however manufactured as completely coated component on at least one of its surfaces, in particular only on the surface situated opposite the gas through-openings, since thus, in particular when using a metallic spring element, a precoated material can be used so that the production cost is limited.

The valve body itself including the wall of the gas through-opening can however advantageously consist of a thermoplastic plastic material, in particular a polyamide, in particular polyamide 6.6, or comprise this. The spring element consists however, particularly advantageously, of spring steel or comprises spring steel. It is essential that the spring element itself and the coating consist of different materials. As sheet metal thickness for the spring element, in particular 0.075 mm to 0.25 mm are suitable, preferably 0.1 mm to 0.2 mm, respectively including or excluding the boundary values of these ranges. As material thickness for thermoplastic spring elements, in particular 0.8 to 2.0 mm are used, respectively including or excluding the boundary values of these ranges.

In further advantageous embodiments of the present invention, two or more gas through-openings can be provided. These can also be disposed in one, two or more groups of respectively one or more gas through-openings. Correspondingly, also two or more spring elements can be provided, one spring element for closing one, several or all of these gas through-openings of this assigned group being provided for example for each of the groups of gas through-openings.

The various spring elements can be configured accordingly also differently so that their opening behaviour respectively can be adjusted individually. Also the coatings of the individual spring elements can be configured in the same way or differently, for example with respect to material or thickness.

Correspondingly, it is not required that all of the gas through-openings are configured in the same way, rather these can have different cross-sections of their inlets, different cross-sections of their outlets, different cross-sections in the intermediate region between their inlets and outlets and also different cross-sectional areas and cross-sectional shapes, for example they can be configured to be round, angular, rectangular, square or generally polygonal, oval and the like.

It is also not required that all of the gas through-openings can be closed by the spring elements. Rather, it is also possible that individual gas through-openings remain permanently unclosed/open. Such gas through-openings consequently represent an emergency bypass for blow-by gases.

Furthermore, in the gas through-openings (in one, several or all of the gas through-openings), elements can be disposed which contribute to a further improvement in the oil separation. For example conducting geometries are suitable for this purpose which set the throughflowing gases in rotation about the axial direction of the gas through-opening and thus lead to a cyclone-like separation of oil mist and oil droplets. Such conducting geometries are disposed for example as at least one helical segment in a gas through-opening, the at least one helical segment and the gas through-opening being able to be produced in one piece. This at least one conducting geometry is integrated in one of the baseplates, their throughflow direction advantageously being essentially perpendicular to the plate plane of the baseplate. Also the individual conducting geometries and also the associated baseplate can be configured in one piece as a common component.

The individual helical segments can thereby have a length (in axial direction) of less than 0.5 pitches. The gas through-opening itself can however have, including an inflow and/or outflow region, a greater length. The pitch is thereby defined as the length of the helical segment in the axial direction of the gas through-opening which the segment would have in the case of a complete revolution of the thread areas by 360°.

Since the helical segments have a length up to at most half a pitch, each baseplate can be produced in one piece as a cast part, in particular as diecast part or injection moulded part. Consequently it is possible to produce the gas through-opening and the helical segment, i.e. the conducting geometry, and their baseplate(s) in the same operation. Hence many gas through-openings can be produced in one operation with integrated helical segment in the same workpiece. Also very small inner diameters are possible hereby for the gas through-openings, for example 3 mm.

In an advantageous embodiment, at least two baseplates produced in this way are disposed adjacent to each other such that the individual gas through-openings of the individual basic carriers are assigned to each other such that respectively one conducting geometry or gas through-opening of one baseplate, with the associated conducting geometry or gas through-opening of the at least one adjacent baseplate, form a common flow path for the gas which extends through all of the adjacently disposed baseplates.

It is particularly advantageous if the direction of rotation (clockwise rotation or anticlockwise rotation) of the gas which is produced by the helical segments hereby changes between adjacently disposed baseplates: if a first segment has an anticlockwise direction of rotation of the screw surfaces of the helical segment in gas flow direction, then the subsequently disposed helical segment has a clockwise direction of rotation of the screw surfaces or of the flow path or of the associated flow paths.

The separation is particularly efficient if, in the case of such a successive arrangement of at least two of such gas through-openings with integrated or integral conducting geometry, the individual segments advantageously have at most a length corresponding to 0.5 times their pitch, also and precisely if the direction of rotation of successive segments is in opposite directions to each other so that the gas must be deflected from the one direction of rotation to the other direction of rotation within the successively connected gas through-openings.

As a result of these helical segments which are disposed in succession with an opposite direction of rotation, impact surfaces on which the oil or the oil mist are separated very well are produced. The screw surfaces of the helical segments can thereby be disposed such that the screw surface of the subsequent segment protrudes into the flow path formed by a screw surface of the preceding segment. It is hereby particularly advantageous if the screw surface of the first segment protrudes for instance up to the centre into the flow path formed by the screw surface of the second adjacent segment.

However, also baseplates with segments configured in the same direction can be disposed adjacent to each other. The outlet-side edge of a first segment and the inlet-side edge of a subsequent second segment, which are disposed adjacent to each other, can advantageously be disposed rotated about the central axis of the common flow path relative to each other by an angle, in particular by an angle between 45° and 135°, particularly preferably by approx. 90°.

Advantageously, the device can be configured furthermore as follows:

The spring element can have a through-opening in the flow direction of the gas flow, axially-concentrically or axially-eccentrically, behind at least one of the gas through-openings.

The diameter of at least one of the through-openings can be smaller than the diameter of the suction-side outlet of the gas through-opening disposed axially in front of the through-opening.

Two or more of the spring elements can have a common fixing region for fixing the spring elements to the valve body.

At least one of the spring elements can be fixed resiliently via at least one retaining arm to the valve body such that it is moveable between a first position, in which it closes the covered gas through-openings, and a second position in which it opens the covered gas through-openings.

At least one of the retaining arms can be fixed such that the spring element fixed via the retaining arm is moveable such that it is successively moved away from the at least two gas through-openings or closes these successively.

At least one of the retaining arms can be fixed such that at least one of the spring elements is moved away in a tilting movement from at least one gas through-opening or moves towards the latter. However, it is likewise possible that the spring element has at least one retaining arm, however preferably at least two retaining arms which have respectively at least two bent regions, for example pre-stamped bent lines, and it is consequently made possible that the cover region is raised essentially parallel from the gas through-opening and again moves towards the latter. Those spring elements which have at least two retaining arms are particularly suitable for this purpose. In the case of two retaining arms, these can thereby be disposed advantageously mirror-symmetrically to an axis extending centrally between these, in particular parallel to each other. In the case of a greater number of retaining arms, in particular in the case of three retaining arms, a rotationally-symmetrical arrangement is advantageous, the retaining arms being disposed preferably at an angle of 360°/n with n the number of retaining arms.

If the spring element has a tongue-shaped construction, the spring element can also be termed spring tongue. Included herein are in particular those spring elements in which the spring plate is retained by a single retaining arm or two retaining arms, the two retaining arms being disposed in particular such that their main direction of extension extends essentially parallel to each other, in particular at an angle of at most 30° to each other. The actual spring element is thereby preferably tongue-shaped or rounded-rectangular. Those spring elements which are disposed and/or joined rotationally-symmetrically via more than two retaining arms are possibly not included herein.

At least one of the spring elements can be fixed, pretensioned, such that it closes the covered gas through-openings if the pressure difference between the side of the spring element orientated towards the gas through-openings and the side of the spring element orientated away from the gas through-openings is below a predetermined threshold value.

The valve body can have at least two groups of gas through-openings which have respectively at least two gas through-openings, and the valve seal has a number of spring elements corresponding to the groups of gas through-openings, each of the spring elements being disposed such that gas flow-openings of one group can be closed at least partially respectively by one of the spring elements.

For each of the spring elements which can be configured in particular as spring tongues, two retaining arms can be provided, which retaining arms extend along two opposite edges of the spring element or the spring tongue and enclose between each other one of the spring elements or the spring tongues in the layer plane of the spring element or spring tongue, the retaining arms being fixed at one of their ends to the valve body and being joined, at their other end, to the spring element or spring tongue, possibly in one piece. The retaining arms, viewed in radial direction, can be joined behind the last gas through-opening which can be closed by the spring element or the spring tongue to the spring element or the spring tongue, possibly in one piece.

In the following, some examples of a device according to the invention are described with reference to Figures. Various elements which are essential to the invention or also develop advantageously within the scope of these examples are thereby mentioned, also some of these elements as such being able to be used for developing the invention—also taken out of the context of the respective example and further features of the respective example. Furthermore, the same or similar reference numbers are used in the Figures for the same or similar elements and explanation thereof can therefore be partly omitted.

There are shown

FIG. 1 a device according to the state of the art;

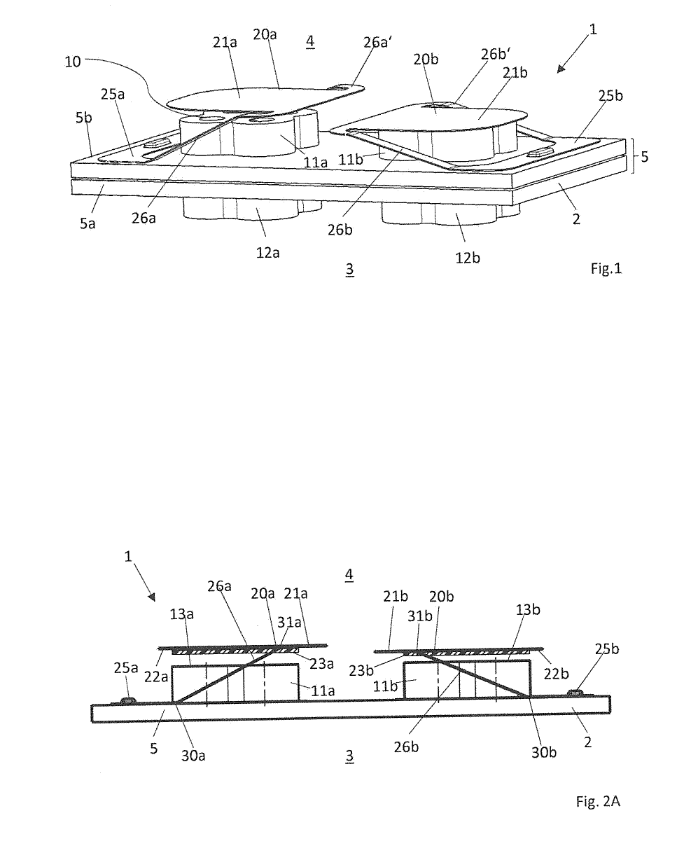

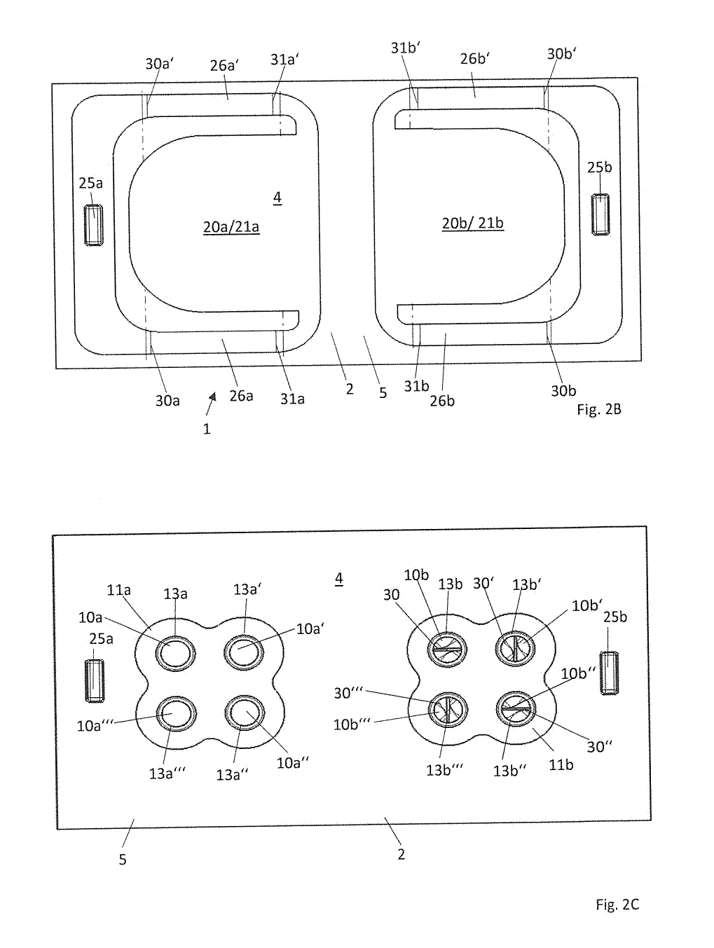

FIGS. 2 to 8 devices according to the invention;

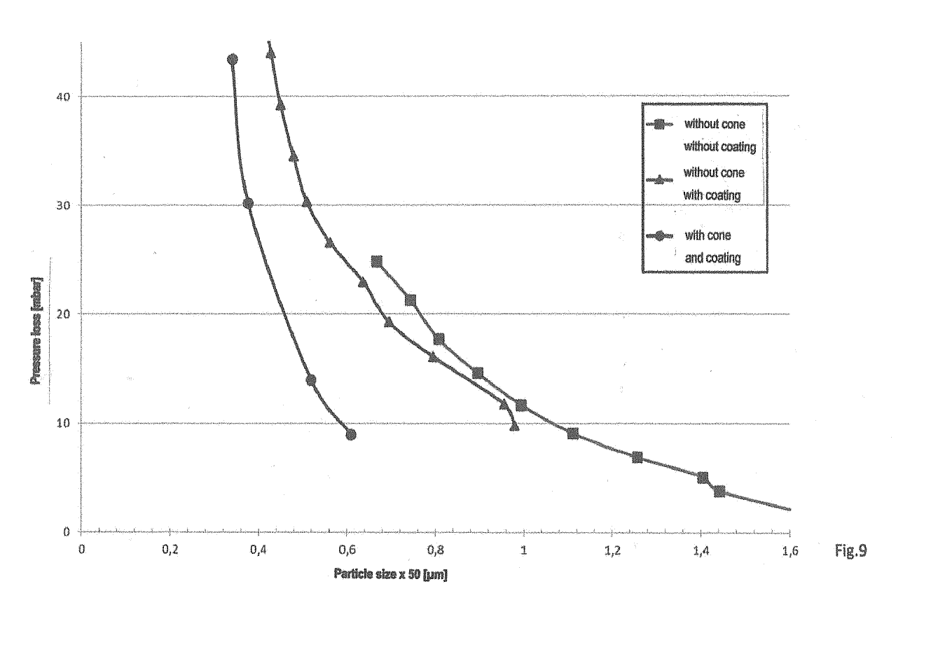

FIG. 9 test results for the separation performance of various oil separators; and

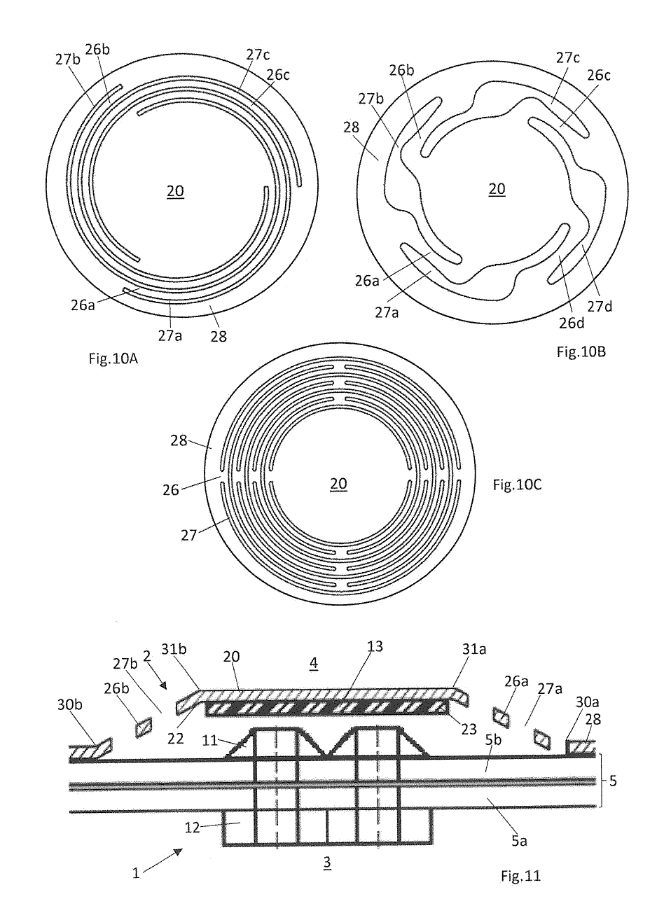

FIGS. 10 to 12 further devices according to the invention and spring elements of devices according to the invention.

FIG. 1 shows a device for separating oil mist and/or oil droplets from blow-by gases of an internal combustion engine. This device 1 has a valve 2. The valve 2, for its part, has two baseplates 5a and 5b which form the valve body 5, the baseplate 5a being disposed on the pressure side (pressure side 3) and the baseplate 5b, on the suction side (suction side 4). Gas through-openings 10 extend through these baseplates 5a and 5b, only one gas through-opening of which is provided in FIG. 1, by way of example, with a reference number. The gas through-openings 10 have radial walls 11 and 12, the wall 11a, 11b, 12a and 12b of which are provided, by way of example, with reference numbers. The walls 11a and 11b are thereby disposed on the baseplate 5b, on the suction side, whilst the walls 12a and 12b are disposed on the baseplate 5a, on the pressure side. In particular, the walls can be configured also in one piece with the respective associated baseplate. Retaining arms 26a and 26b are disposed at fixing regions 25a and 25b of the baseplate 5b, which retaining arms respectively retain a spring element 20a or 20b configured as spring tongue 21a or 21b. These spring tongues 21a and 21b are consequently mounted elastically and can move between two states in which the gas through-openings 10 are unclosed or closed. The unclosed/opened state is represented for the spring tongue 21a, whilst the closed state is represented for the spring tongue 21b.

In FIG. 2A, an embodiment according to the present invention is represented in side view, which has however, in contrast to FIG. 1, merely a single baseplate 5 which includes gas through-openings with wall 11a and 11b. This device 1 from FIG. 2A can however readily be supplemented by a corresponding baseplate 5a from FIG. 1 on the pressure side.

This device 1, relative to the device in FIG. 1, is developed according to the invention by, as illustrated in FIG. 2A, the spring elements 20a and 20b configured in turn as spring tongue 21a and 21b having respectively a coating 23a and 23b made of an elastomeric material 33a, 33b which is disposed respectively on that surface of the spring tongue which is orientated towards the gas through-openings 10. In the present embodiment, the coatings 23a, 23b are partial coatings.

FIG. 2B shows a plan view on the baseplate 5 of the device from FIG. 2A, which forms the valve body at the same time. The spring tongues 21a and 21b are retained respectively by lateral retaining arms 26a, 26a′ or 26b, 26b′ at fixing regions 25a or 25b. In particular from FIG. 2A, it becomes clear that the retaining arms 26a, 26a′, 26b and 26b′ respectively have two bent places 30a, 31a or 30a′, 31a′ or 30b, 31b or 30b′, 31b′ so that the spring elements 20a, 20b extend respectively essentially parallel to the baseplate 5 and maintain this orientation even when moving away from and approaching the baseplate 5. FIG. 2C shows a plan view on the baseplate 5 from the suction side 4. To each of the spring tongues 21a and 21b from FIG. 2B, now not illustrated here, a group of gas through-openings 10a, 10a′, 10a″, 10a′″ or 10b, 10b′, 10b″, 10b′″ is assigned respectively. The gas through-openings, mentioned subsequently only for the group assigned to the spring tongue 21a, has a wall 11a which surrounds, in one piece, all of the gas through-openings 10a, 10a′, 10a″, 10a′″. According to the invention, each of the gas through-openings 10a to 10a′″ has a cover region 13a to 13a′″ which protrudes in particular from the wall 11a, however is part of the wall 11a at the same time. In these cover regions 13a to 13a′″, the spring tongue 21a comes in contact with the wall 11a during closure of the gas through-openings 10a to 10a′″.

Similarly, this applies for the gas through-openings 10b to 10′″ and the spring tongue 21b. The gas through-openings 10b to 10b′″ are furthermore provided with conducting geometries which extend helically in the form of a helix in axial direction of the through-openings 10b to 10b′″ and set the blow-by gas in a rotational movement during throughflow of the blow-by gas through the gas through-openings 10b to 10b′″. As a result, the separation degree of the respective gas through-opening 10b to 10b′″ is improved.

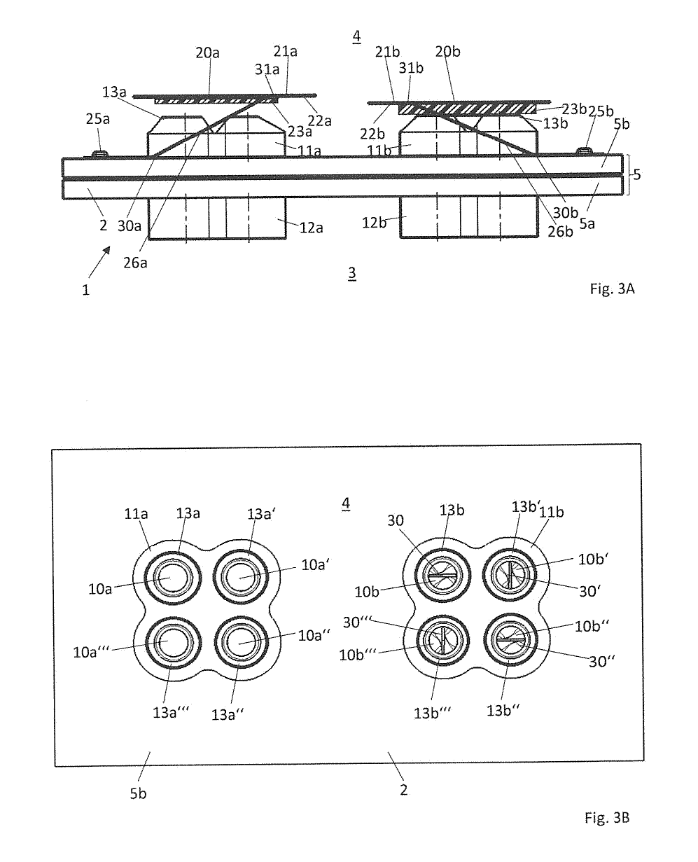

FIG. 3 shows an example of a further device 1 according to the invention. In contrast to the device according to FIG. 2, here both spring tongues 21a and 21b are provided with coatings of different thicknesses, namely with 0.3 mm or 0.6 mm FKM.

Furthermore, the gas through-openings or walls 11a, 11b thereof are provided, according to the invention, with cover regions 13a, 13b in which the wall for each individual gas through-opening has a thickness in the direction of its end which tapers conically. As a result, a narrow contact surface is produced as cover region 13a, 13b between the respective coating 23a or 23b, on the surfaces 22a and 22b, orientated towards the gas through-openings, of the spring tongues 21a or 21b with the walls 11a, 11b. This becomes clear in particular from the side view of FIG. 3A.

In the case of the device 1 according to FIG. 3, furthermore an additional baseplate 5a is provided, as was illustrated already in FIG. 1.

FIG. 3B now shows a plan view on the baseplate 5b, the spring tongues and also their fixing regions and retaining arms being omitted in the illustration. In contrast to the walls 11a and 11b in FIG. 2, the walls 11a and 11b in FIG. 3 are now configured such that cover regions 13a to 13a′″ or 13b to 13b′″ are raised from this wall in the direction of the spring tongues, in which cover regions the thickness of the wall tapers in the direction of the spring tongue.

FIG. 4 shows a further device 1 according to the invention in which however merely one single group of gas through-openings is provided, in side view. FIG. 4A and FIG. 4B thereby show the opened state in FIG. 4A and the closed state in FIG. 4B.

By means of the sharp edge of the wall 11 in the cover region 13, a narrow precise gap between the coating 23 and the suction-side end of the wall 11 is produced, as illustrated in FIG. 4A. This precise gap leads to an improved oil separation during passage of the blow-by gases through the gas through-opening and through the gap between the wall 11 and the coating 23. The coating 23 consists here of FVMQ with a layer thickness of 0.4 mm and a hardness of 59 Shore A, in fact no gas flow being able to be effected through this closed-pore material 33 of the coating 23 but nevertheless good separation of the oil on the surface being effected.

In FIG. 4B, the closed state is illustrated in which the suction-side edge of the wall 11 is closed about each of the gas through-openings by the coating 23. The edge of the wall 11 is thereby pressed into the elastomeric coating 23 so that a further improved closure of the gas through-openings is effected.

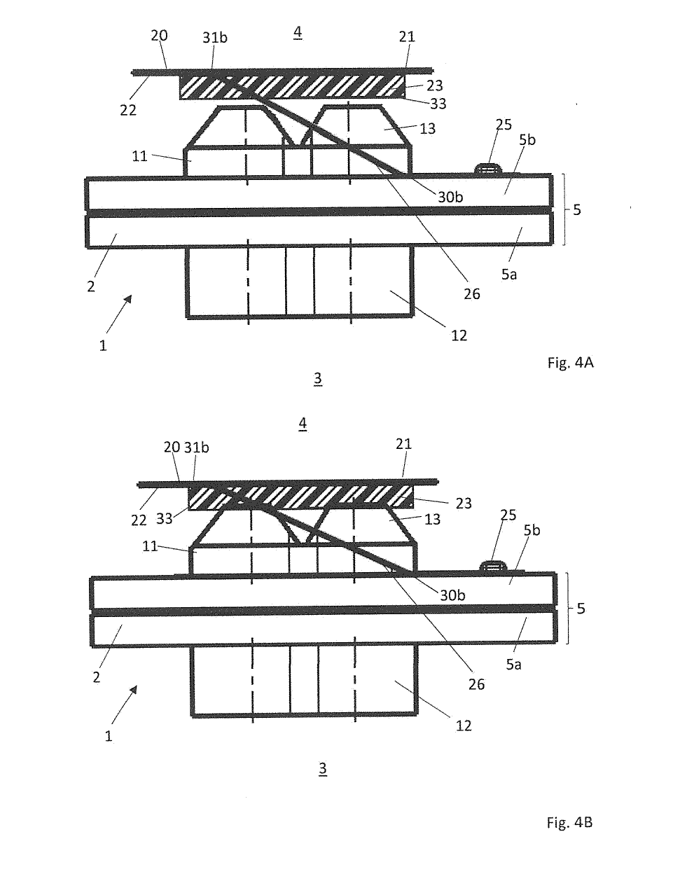

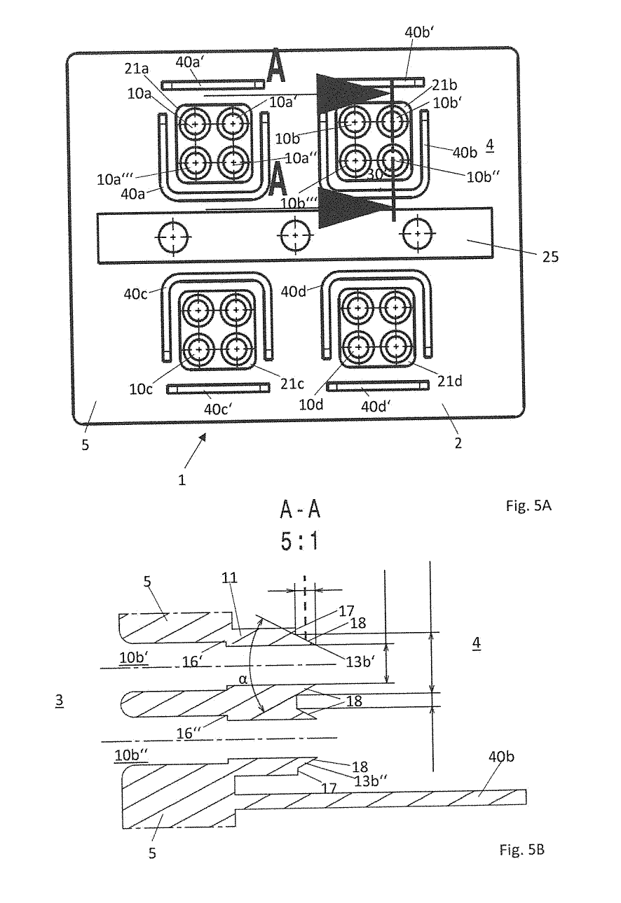

FIG. 5 shows a further embodiment of the device 1 according to the invention in plan view. In the case of this device 1, in total four groups of gas through-openings 10a to 10a′″, 10b to 10b′″, 10c to 10c′″, 10d to 10d′″ are provided (merely a part of the gas through-openings has been provided with reference numbers). All of the spring elements, not visible here, for the respective groups of gas through-openings have a common fixing region 25. In the case of the illustrated plan view of FIG. 5A, the spring elements are not illustrated in order to show the other construction situated below the spring elements.

The device 1 has furthermore walls 40a, 40a′ or 40b, 40b′ or 40c, 40c′ or 40d, 40d′ which surround the gas through-openings and lead to a further improved separation of oil mist and oil droplets.

FIG. 5B shows a cross-section along the line A-A in FIG. 5A through two gas through-openings 10b′, 10b″. This cross-section is rotated to the right by 90°, compared with the side views of FIGS. 2A, 3A, 4A and 4B, shown previously. The gas through-openings 10b′, 10b″ are thereby configured essentially mirror-symmetrically relative to each other. The walls 11 of the gas through-openings 10b, 10b″ thereby protrude from the baseplate 5. In axial direction through the baseplate 5 and the walls 11, the cross-section through the gas through-opening 10b′, 10b″ has steps 16′, 16″ so that the cross-section of the gas through-opening is smaller in the region of the wall 11 than in the region of the baseplate 5. In the direction of the suction side 4, the wall tapers initially in the form of steps 17 and thereafter in a conical shape at its suction-side end, tapering between the outer surface in a chamfered region 18 and the inner surface of the wall 11. The angle between the outer surface in the region 18 and the inner surface is thereby □/2, in the present case of FIG. 5B, 30°. The angle is thereby determined however not along the total chamfered region but merely between the left end of the chamfered region and the broken line. As a result of the precise edge between the outer surface and the inner surface of the wall 11 on its suction-side end, a further improved oil separation for throughflowing gases is produced in particular by the interaction with the coating of the spring element.

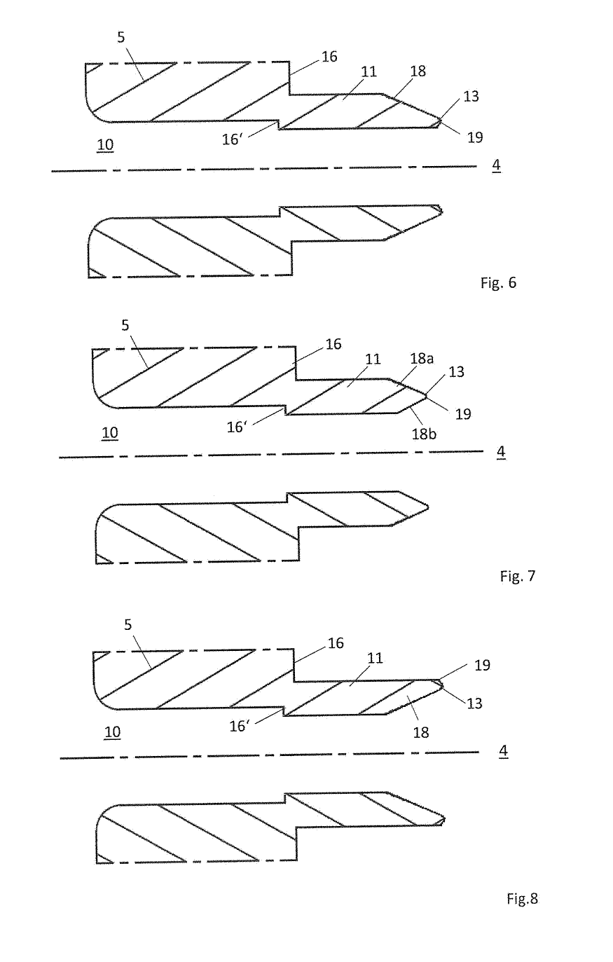

FIGS. 6 to 8 show further cross-sections through walls 11 of gas through-openings 10 according to the invention, only one gas through-opening being illustrated respectively here, differently from FIG. 5B.

In FIG. 6, the end region on the suction side 4 of the wall 11 tapers and has a radius of curvature 19 at the sharp end. The radius of curvature 19, in the present example, is approx. 0.3 mm.

In FIG. 7, the wall 11 is chamfered/bevelled from both sides so that it tapers to a suction-side, sharp end which, viewed microscopically, therefore likewise has a very small radius of curvature of approx. 0.15 mm.

In FIG. 8, the wall 11 on its inside orientated towards the gas through-opening 10 is chamfered, widening conically in the cover region 13. Also on the outside, a short chamfer is provided which changes via a radius 19 into the chamfer 18 of the outer surface of the wall 11.

All these embodiments lead to an improved separation of oil mist and oil droplets, compared with the state of the art.

FIG. 9 shows measured results on various devices corresponding to the present invention. Respectively the measured pressure loss between pressure side and suction side is thereby determined, which pressure loss occurs during separation of specific particle sizes or is required for separation of such particle sizes. The smaller the occurring pressure loss for separation of particles with a specific particle size, the greater is the efficiency of the respective oil-separating valve.

In FIG. 9, the measured results are plotted for a device according to FIG. 1 from the state of the art (“without cone without coating”) in which the suction-side end of the walls of the gas through-openings is not chamfered conically and the spring tongue has no coating.

Furthermore, measured results are illustrated with devices which have in addition a coating of the spring tongue with 0.4 mm FVMQ in which the suction-side end of the walls of the gas through-openings is not chamfered conically (“without cone with coating”) and also measured results with a device in which both the wall according to FIG. 5B is chamfered conically and the spring tongue is provided with a 0.4 mm thick coating made of FVMQ (“with cone and coating”).

It is shown that in fact the coating of the spring tongue according to the invention leads to great improvement in the separation efficiency. If in addition the suction-side end of the walls of the gas through-openings are also chamfered conically, then the separation efficiency is further improved disproportionately.

In the partial FIGS. 10A, 10B and 10C, FIG. 10 shows three alternative embodiments of spring elements 20 in plan view, as can be used in the device 1 according to the invention. Differently from the spring elements 20 of the preceding embodiments, configured as spring tongues 21, the spring elements 20 shown here have an essentially round configuration. The connection to the valve body is not effected directly via the retaining arms but in the edge region 28 surrounding the retaining arms.

The embodiment of FIG. 10A thereby has three retaining arms 26a, 26b, 26c which are disposed respectively offset relative to each other by 120° and extend helically. The retaining arms 26a, 26b, 26c in the embodiment of FIG. 10A are configured respectively with a constant width. Between the retaining arms 26a, 26b, 26c, slots or narrow recesses 27a, 27b, 27c are configured, which widen during opening of the valve and narrow during closure of the valve. As in the preceding embodiments, the valve element 20 thereby moves essentially parallel to the plane of the valve body.

In the embodiment of FIG. 10B, the valve element 20 is fixed or is to be fixed via four retaining arms 26a to 26d and the edge region 18. The retaining arms 26a to 26d hereby have a width which changes over their course, just as the recesses 27a to 27d. The retaining arms are configured rotationally-symmetrically relative to each other. Their shape can be changed by rotation by 90° or an integral multiple of 90° about the centre of rotation.

The embodiment of FIG. 10C has a branched retaining arm system which is regarded here as one retaining arm 26 since all of the branches are connected to each other. As in both embodiments of FIGS. 10A and 10B, the movement of the spring element 20 is effected essentially parallel to the plane of a valve body 5, not shown here.

In FIG. 11, a device according to the invention with a spring element 20, comparable to that of FIG. 10A, is shown in section in the opened state of the valve 2. The cross-section is thereby similar to that of FIG. 4A. Relative to FIG. 4; the projection of the walls 11 beyond the layer 5A is reduced, the total wall portion 11 is configured conically tapering and no cylindrical portion of the wall 11 is provided. The spring element 20 is connected via in total three retaining arms, only the two retaining arms 26a, 26b being visible in the illustrated section and the fixing regions being situated outside the shown section.

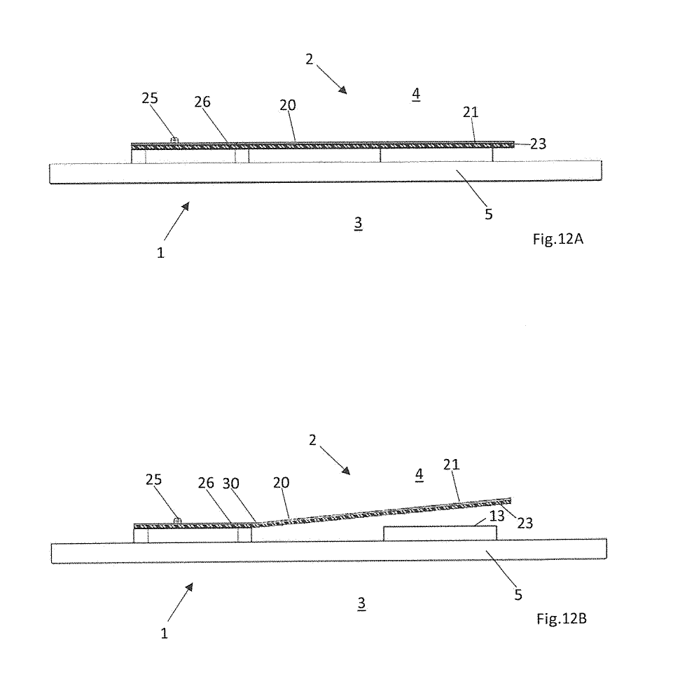

In FIG. 12, a device 1 according to the invention is shown in side view in both partial pictures 12A and 12B, FIG. 12A thereby shows the closed state, FIG. 12B the opened state of the valve. The spring element 20 is manufactured from an elastomer-coated material which is closed-pore completely on one side, for example a metal sheet, so that the coating 23 extends up to the edges of the spring element 20. Differently from the preceding embodiments, the spring element 20 is fixed via only one retaining arm 26 to the valve body or the baseplate 5 and is hence configured as spring tongue. Because of the one-sided fixing in the fixing region 25, the spring element 20 configured as spring tongue 21 is raised in a tilting movement from the cover region 13 and opens the latter—as a function of the arrangement and the spacing of the through-openings, covered in common by one spring element, and the elasticity of the spring element and its coating—either simultaneously or successively. This can be advantageous in particular if switching states of the device are consequently achievable in which a part of the through-openings is opened whilst another part of the through-openings is still closed by the spring element 20. Also in the case of a spring tongue coated in this way, the separation performance of the gap between the valve opening and the spring tongue is improved by the closed-pore, elastomeric coating.

It is essential here, as therefore for the entire present invention, that the spring element is coated elastomerically such that the separation performance for oil mist or oil droplets at the spring element is improved. Other properties of the elastomeric material need not thereby be considered, for example its cushioning properties on the resilient behaviour of the spring element or the closing behaviour of the spring element since this is not important in the present invention.

1-19 (canceled)

20. A device for separating oil droplets and/or oil mist from blow-by gases of an internal combustion engine having a valve for controlling the gas flow from a pressure side to a suction side of the oil separator,
the valve having a valve body with at least one gas through-opening from the pressure side to the suction side of the valve and also a valve seal for suction-side closure of at least one of the gas through-openings of the valve body,
the valve seal having at least one spring element which is configured such that at least one of the gas through-openings can be closed by the spring element, wherein
at least one of the spring elements, via which at least one of the gas through-openings can be closed, is coated with an elastic material on the surface which is orientated towards the gas through-opening in the region of at least one of the gas through-opening.

21. The device according to claim 20, wherein the valve body has at least one baseplate in which at least one gas through-opening is disposed, at least one of the gas through-openings being delimited in a radial direction by respectively a wall which protrudes in the direction of the spring element beyond the baseplate.

22. The device according to claim 21, wherein the case of at least one gas through-opening, a cover region of the wall which is directly adjacent to the spring element and extends from the open end over ≥1 mm, has a wall thickness of ≤1 mm.

23. The device according to claim 22, wherein the case of at least one gas through-opening, a cover region of the wall which is directly adjacent to the spring element and extends from the open end over ≥0.5 mm, has a wall thickness of ≤0.5 mm.

24. The device according to claim 23, wherein the case of at least one gas through-opening, a cover region of the wall which is directly adjacent to the spring element and extends from the open end over ≥0.1 mm, has a wall thickness of ≤0.2 mm.

25. The device according to claim 24, wherein the wall thickness of the wall in the cover region is configured, at least in regions along the circumferential edge of the through-opening, such that, if a spring element which is coated with the elastic material closes the gas through-opening, the ratio between, on the one hand,
a) the cross-sectional area of the gas through-opening at the open end of the wall; or
b) the area of the elastic material, which is surrounded by the contact surface of the wall with the elastic material;
and, on the other hand, the contact area between the wall and the elastic material is ≤50.

26. The device according to claim 25, wherein the wall in the cover region, at least in regions along the circumferential edge of the through-opening, has an edge having a radius of curvature of ≤0.1 mm.

27. The device according to claim 25, wherein the wall in the cover region, at least in regions along the circumferential edge of the through-opening, has an edge for at least one gas through-opening, at which the inner and outer surface of the wall converge at an angle of ≤15°.

28. The device according to claim 20, wherein the material of the coating of the spring element consists of an elastomer, comprising polyacrylate rubber (ACM), ethylene acrylate rubber (AEM), fluorosilicone rubber (FVMQ), fluorinated rubber (FKM), silicone rubber (VMQ), epichlorohydrin rubber (ECO), perfluorinated rubber (FFKM), nitrile-butadiene rubber (NBR), hydrated nitrile-butadiene rubber (HNBR), chloroprene rubber (CR), thermoplastic elastomers (TPE), and also blends and/or mixtures of these materials.

29. The device according to claim 20, wherein the material of the coating of the spring element is, at least in regions, a closed-pore material.

30. The device according to claim 20, wherein the thickness of the coating is from 0.35 to 0.5 mm.

31. The device according to claim 20, wherein the valve body is comprised of a thermoplastic plastic material, including a polyamide, and polyamide 6.6.

32. The device according to claim 20, wherein at least one of the spring elements is comprised of spring steel.

33. The device according to claim 32, wherein one, or several or all of the spring elements has a sheet metal thickness of 0.1 to 0.2 mm.

34. The device according to claim 20, wherein two or more spring elements are provided.

35. The device according to claim 34, wherein the coatings are made of respectively different materials and/or with different material thicknesses and are applied on different spring elements.

36. The device according to claim 20, wherein one, several or all of the spring elements are configured as spring tongue.

37. The device according to clam 20, wherein at least two gas through-openings, which are covered by different spring elements, have different cross-sections of their inlets and/or outlets and/or centrally between their inlets and outlets, including relative to the cross-sectional area and/or cross-sectional shape.

38. The device according to claim 20, wherein, in at least one of the gas through-openings, a conducting geometry is disposed, which sets the through-flowing gases in a rotation about the axial direction of the gas through-opening.
